(19) United States
(12) Patent Application Publication
(10) Pub. No.: US 2026/0336735 A1
(43) Pub. Date: Oct. 29, 2026

(54) SAFETY SYSTEM

(71) Applicant: Kiichi's MEMO Inc., Tokyo (JP)

(72) Inventor: Kiichi MORIYA, Tokyo (JP)

(73) Assignee: Kiichi's MEMO Inc., Tokyo (JP)

(21) Appl. No.: 19/115,359

(22) PCT Filed: Sep. 30, 2022
(86) PCT No.: PCT/JP2022/036635

§ 371 Date: Mar. 26, 2025

(51) Int. Cl. B62H 5/00; B62H 5/14; B62H 5/20; B62J 45/416; B62J 45/42

(52) U.S. Cl. CPC B62H 5/001; B62H 5/147; B62H 5/20; B62J 45/416; B62J 45/42

(57) ABSTRACT

A safety system includes a helmet part that is attachable to a helmet and a lock part that is attachable to a vehicle and can lock the vehicle. The helmet part includes a wearing sensor that detects that the helmet is being worn, and the lock part includes a lock mechanism that releases a lock of the vehicle through manual unlocking and a permission unit that permits the manual unlocking of the lock mechanism when wearing of the helmet is detected by the wearing sensor.

### TECHNICAL FIELD

The present invention relates to a safety system for encouraging helmet wearing and reducing a risk of death due to head injury, when using a vehicle such as a bicycle.

### BACKGROUND

Most critical injuries in bicycle accidents are suffered to the head. The fact that wearing a helmet is not mandatory in Japan is raised as a main cause thereof. Accordingly, helmet wearing when using a bicycle is low, and the situation is such that major accidents due to head injury occur. It has been reported that the fatality rate when not wearing a helmet is 2.5 times higher than when wearing a helmet.

Parents generally encourage their children to wear a helmet, but it is known that a certain number of children remove their helmet when not under parent supervision, and the practice of wearing a helmet at all times has not taken hold yet.

In view of such a situation, a technique exists for encouraging helmet wearing by making it impossible to ride a bicycle when not wearing a helmet. For example, the invention of Patent Literature 1 discloses a system in which electrical contacts are provided inside the helmet and on belt buckles. Helmet wearing is detected through connection of these contacts, and a restriction on wheel rotation is released allowing the bicycle to be ridden when helmet wearing is detected.

### PATENT LITERATURE

Patent Literature 1: U.S. Pat. No. 7,973,652

### SUMMARY

However, the invention of Patent Literature 1 has a problem that when the helmet being worn is displaced due to some type of momentum or when a contact point malfunctions, the system detects that the helmet is not being worn, and wheel rotation is locked due to this detection result even when riding the bicycle, resulting in an exceedingly dangerous situation.

In order to solve the above-described problem, the following safety system and the like is provided in the present invention. That is, a safety system is provided that includes a helmet part that is attachable to a helmet and a lock part that is attachable to a vehicle and can lock the vehicle, wherein the helmet part includes a wearing sensor that detects that the helmet is being worn, and the lock part includes a lock mechanism that releases a lock of the vehicle through manual unlocking and a permission unit that permits the manual unlocking of the lock mechanism when wearing of the helmet is detected by the wearing sensor.

According to the present invention, it is possible to encourage helmet wearing, and to avoid a dangerous situation in which a wheel is immediately locked when the helmet is mistakenly detected as not being worn.

### BRIEF DESCRIPTION OF DRAWINGS

FIG. 1 is a conceptual diagram showing an overview of a safety system according to the present embodiment.

FIG. 2 is a block diagram showing a configuration example of the safety system according to the present embodiment.

FIG. 3 is a conceptual diagram showing a configuration example of hardware realizing the safety system.

FIG. 4 is a flow diagram showing a flow example of processing of a helmet part.

FIG. 5 is a flow diagram showing a flow example of processing of permitting a lock mechanism of a lock part to be released.

### DETAILED DESCRIPTION

Hereinafter, embodiments according to the present invention are described with reference to the accompanying drawings. These embodiments are not intended to limit the present invention, and the present invention can be realized in various aspects without departing from the scope thereof.

### Embodiment

### <Overview>

A safety system according to the present embodiment permits manual unlocking for releasing a lock mechanism of a bicycle, by wearing a helmet. Wearing a helmet is encouraged when riding a bicycle, since a helmet must be worn in order to ride the bicycle. On the other hand, locking and unlocking of the lock mechanism is not directly linked to wearing a helmet, and the present invention makes it possible to avoid a situation in which a bicycle is locked while traveling due to a malfunction or erroneous detection, by interposing manual unlocking.

Functions, a processing flow, and hardware of the safety system will be described below. Note that function blocks of the safety system described below may be realized as a combination of hardware and software. To be specific, when using a computer, examples include: a hardware component unit such as a central processing unit (CPU), a main memory, a bus, a secondary storage device (a hard disk drive, a non-volatile memory, or the like), an input device that is utilized for inputting information, printing equipment, a display apparatus, and external peripheral apparatuses; an interface for the external peripheral apparatuses; an interface for communication; driver programs for controlling these pieces of hardware; other application programs; and an application for a user interface. The CPU executes arithmetic processing in accordance with a program loaded into the main memory, so that processing and storing of the data input via the input device or the interface and stored in the memory or on the hard disk are executed, and instructions to control the hardware and software are generated. Alternatively, the function blocks of the present system may be realized by dedicated hardware.

The present invention can be implemented not only as a system, but also as a method thereof. A portion of such an invention can be implemented as software. A program used for causing a computer to execute such software, and a recording medium on which the program is recorded are included in the technical scope of the present invention (the same applies throughout the present specification).

### <Functional Configuration>

### <Overview>

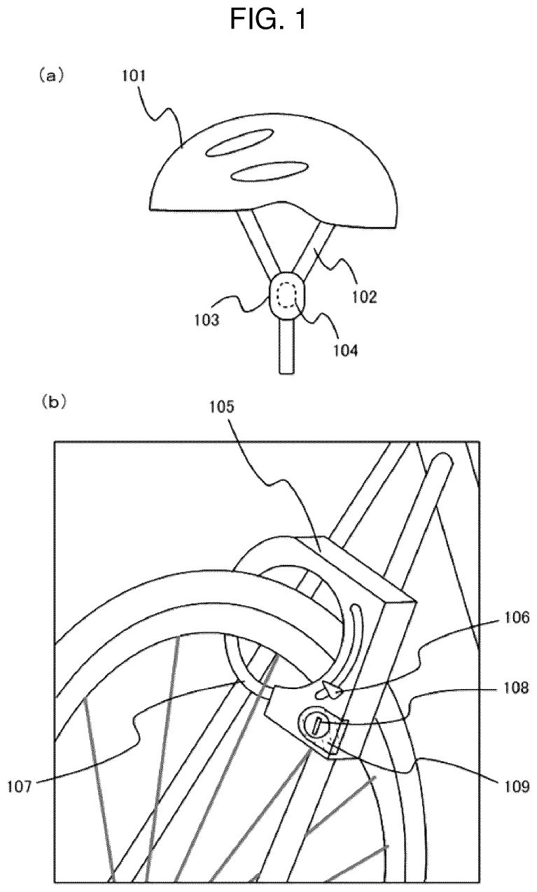

FIG. 1 is a conceptual diagram showing an overview of the safety system according to the present embodiment. FIG. 1(a) shows a helmet 101 and FIG. 1(b) shows a portion in which a lock part 105 is attached to a frame (rear fork) of a bicycle. A helmet part 103 is attached to a belt 102 of the helmet 101. This helmet part 103 includes a heartbeat sensor 104 capable of detecting that a person is wearing a helmet.

The lock part 105 including a ring lock-type lock mechanism for locking a rear wheel via a bolt 107 is attached to the bicycle. The bolt 107 can be opened and closed by a knob 106.

When the heartbeat sensor 104 detects that the helmet 101 is being worn, the lock part 105 unlocks the wheel by inserting a key into a keyhole 108 and opening the bolt 107 via the knob 106. In other words, the bicycle cannot be moved as long as a helmet is not worn. A light-emitting element 109 such as an LED may be disposed around the keyhole 108 so that a state of the lock part 105 can be easily determined.

On the other hand, a detection result of the heartbeat sensor 104 and releasing of the lock are not directly linked, and it is possible to avoid a dangerous incident in which the bicycle is locked while traveling like in the related art, by interposing an action such as manual unlocking.

### <Configuration>

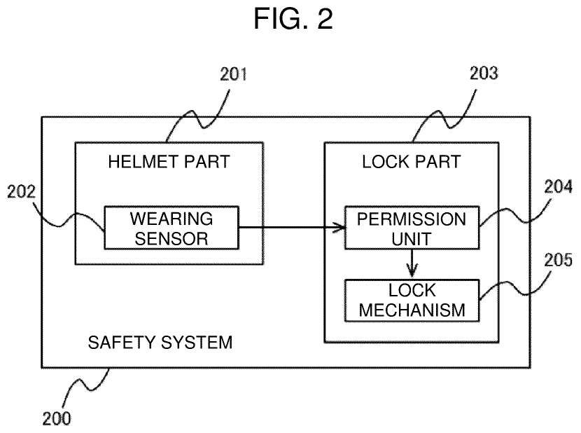

FIG. 2 is a block diagram showing a configuration example of the safety system according to the present embodiment. As shown in FIG. 2, a safety system 200 includes a helmet part 201, a wearing sensor 202, a lock part 203, a permission unit 204, and a lock mechanism 205.

A helmet part 201 is attachable to a helmet and can be attached to a belt that hangs over and is fastened to the jaw as exemplified in FIG. 1, for example. The helmet part 201 may be attached to a shell of a helmet, preferably attached to a belt from the viewpoint of attaching the helmet part 201 to a ready-made helmet with no or minimal machining. The specific manner in which the helmet part 201 is attached to a belt may be, for example, by using a known instrument for attachment, such as a clip or a hook and loop fastener.

The wearing sensor 202 is provided on the helmet part 201 and detects that a helmet is being worn via any type of sensor. Various sensor types can be considered. For example, a pressure sensor or a temperature sensor may be used to detect helmet wearing by detecting contact with the human body.

The wearing sensor is preferably a heartbeat sensor that can detect a heartbeat unique to humans. Erroneous detection of helmet wearing is less likely to occur, by using a heartbeat sensor as the wearing sensor.

As described above, when attaching the helmet part 201 to a belt that hangs over the jaw, the wearing sensor 202 being a heartbeat sensor is disposed on the helmet part 201 at a position at which the wearing sensor 202 can detect the heartbeat when the helmet is put on and the belt is fastened. It is preferable to position the heartbeat sensor so that the heartbeat sensor contacts the neck where the heartbeat can be easily detected.

Detection method of the heartbeat sensor is not particularly limited. Heartbeat sensors are realized through various methods, including electrode type (measuring impedance fluctuation), piezoelectric type using a piezoelectric element, air tube type, capacitance type, optical type (using hemoglobin concentration-attributable absorbance fluctuation), and radio wave type. Naturally, the heartbeat sensor may use any method and not only the methods exemplified, as long as the method is capable of detecting a heartbeat.

The heartbeat sensor may be a sensor module unit capable of detecting biometric information other than a heartbeat. For example, a sensor module installed in a wearable terminal can detect various biometric information such as a heartbeat, blood pressure, blood oxygen saturation, respiration, brain waves, and body temperature. Such a sensor module may be used as a heartbeat sensor.

The wearing sensor 202 has a function of transmitting the detection result to the lock part 203 or the permission unit 204 included in the lock part 203. The detection result to be transmitted includes a detection result indicating that the helmet is being worn and a detection result indicating that the helmet is not being worn. Since an amount of information (detection result) to be transmitted is not large and a transmission distance between the helmet and the bicycle is short, it is sufficient to select a means allowing wireless communication over a short distance, for example, a short-distance wireless communication standard such as IEEE 802.15.4 often used in sensor networks, which also allows power saving. The wearing sensor for detecting helmet wearing, the transmission means for transmitting the detection result, and a microcontroller or battery for driving the wearing sensor and the transmission means may be integrally formed.

Furthermore, the helmet may include an acceleration sensor or a vibration sensor to detect a movement of the helmet such as lifting of the helmet and to activate detection processing of the heartbeat sensor and transmission processing of a detection result as a trigger of the detection result. According to such a configuration, power saving can be achieved by putting the system in a power-saving mode in which power supply to the heartbeat sensor and the transmission means is stopped, since riding a bicycle with a helmet is not expected while the vibration sensor or the like is not detecting any movement.

On the other hand, by detecting a movement of the helmet such as a child starting to move with the helmet, subsequent processing by the helmet part is started without requiring any operation by the child for activation, and helmet wearing can be reliably encouraged by accordingly activating the lock part, as described below.

The lock part 203 is attachable to a vehicle and can lock the vehicle. The vehicle is locked by the lock mechanism 205 described below. The lock part 203 may be attached to the vehicle so that the vehicle can be locked, by using, for example, a known attachment fitting or the like attached to a frame such as the rear fork of the bicycle, as shown in FIG. 1.

The lock mechanism 205 releases a lock of the vehicle through manual unlocking. A specific means for locking the vehicle is not limited. For example, in addition to the ring lock as shown in FIG. 1, a box lock (front wheel lock, front lock), a wire lock, a U-shaped lock (shackle lock), a joint wire lock, or the like can be used. The lock may also be of a type for locking the handlebars. In any case, the bicycle may have a mechanism for restraining the bicycle from moving freely, and the lock mechanism may allow for manual unlocking. The manual unlocking may be done by inserting a key and rotating the inserted key, or by pressing a button or turning a dial.

The permission unit 204 has a function of permitting the manual unlocking of the lock mechanism 205, when wearing of the helmet is detected by the wearing sensor 202. The permission unit 204 receives the detection result indicating that the helmet is being worn, either by itself or via a reception means included in the lock part.

For example, in the case of the lock mechanism 205 using a ring lock, the permission unit 204 permits a series of unlocking operations, such as inserting and turning the key and moving the knob linked to the bolt. In contract, when the detection result is received indicating that the helmet is not being worn, an entirety or a portion of the above series of unlocking operations is not performed. For example, the knob may be prevented from being moved even when inserting and turning the key, or the key itself may be prevented from being turned or inserted in the first place. Note that the permission unit 204 permitting or prohibiting the manual unlocking of the lock mechanism 205 may be expressed as controlling the unlocking of the lock mechanism (hereinafter in the specification).

In order to prevent theft of the vehicle or the like, the lock part 203 preferably includes a means for emitting an alarm to encourage locking when the ride has ended and the helmet is removed. For example, when the helmet is removed, the alarm means may sound a buzzer. Alternatively the alarm means may visually gather attention by causing the light-emitting element disposed around the keyhole as shown in FIG. 1 to blink or change color, in addition to or instead of the buzzer. In this case, the alarm may be stopped by wearing the helmet again or locking the vehicle.

Saving power may be achieved through the permission unit 204 placing functions other than the reception means (means for control of the lock mechanism 205, light emission, or the warning and the like) in a power-saving mode in which power feeding is halted to the functions other than the reception means until the detection result from the wearing sensor 202 is received or until communication is established between the transmission means of the wearing sensor 202 and the reception means of the permission unit 204. When using short-range wireless communication, the lock part 203 in the power-saving mode is activated due to the helmet part 201 approaching the lock part 203 at a distance where the helmet part 201 can communicate with the lock part 203.

As described above, the system can be configured so that activation in the power-saving mode or changing from an activated state to the power-saving mode is performed without requiring a special operation. This is because it is possible then to ride the vehicle without wearing a helmet due to this operation being forgotten or intentionally not being performed by the rider, if an operation is required for activation. Since power saving can be achieved by transitioning to the power-saving mode without requiring a special operation or the like, the frequency of actions for maintaining a power source, such as battery replacement and recharging, can be significantly reduced. This makes it possible to prevent a situation in which using the present system becomes troublesome due to having to frequently perform battery replacement and recharging. Since helmet wearing is reliably encouraged while performing a series of actions up to normal riding without requiring a special operation, the risk of serious injury due to not wearing a helmet can be suppressed and safe use of the present system can be achieved.

### <Hardware Configuration>

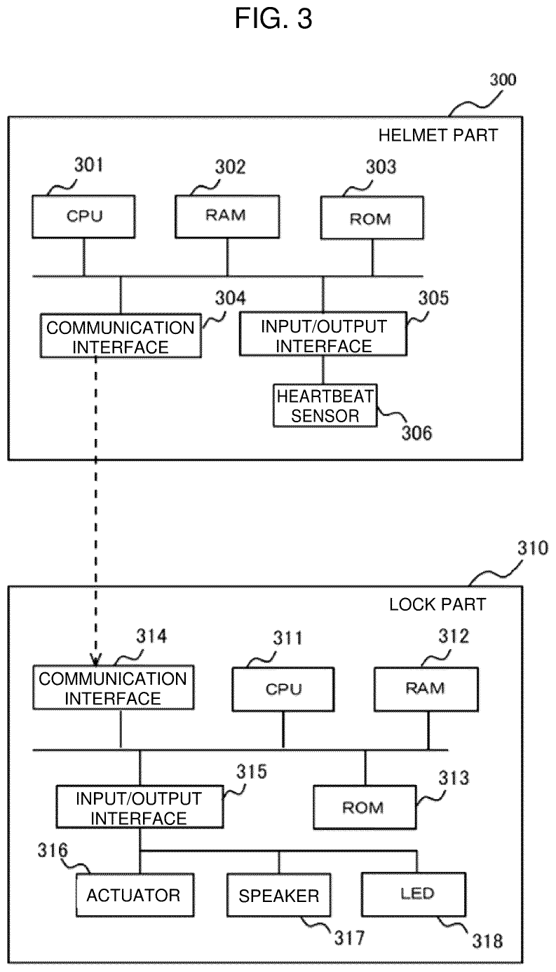

FIG. 3 is a conceptual diagram showing a configuration example of hardware realizing the safety system. As shown in the drawing, a helmet part 300 in the safety system includes a CPU 301 that performs various arithmetic processing, a RAM 302 being a volatile storage medium, a ROM 303 being a non-volatile storage medium, a communication interface 304, and an input/output interface 305. The helmet part 300 is connected to a heartbeat sensor 306 via the input/output interface 305. The RAM 302 loads a program to be executed by the CPU 301 for performing various arithmetic processing and provides a work area for the program. A plurality of addresses is allocated to the RAM 302, and the program executed by the CPU 301 makes it possible to perform processing of identifying and accessing these addresses to perform data exchange between the addresses (the same applies throughout the present specification).

A lock part 310 includes a CPU 311, a RAM 312 being a volatile storage medium, a ROM 313, a communication interface 314, and an input/output interface 315. The lock part 310 is connected to, via the input/output interface 315, an actuator 316 for permitting or prohibiting unlocking, a speaker 317 that emits a warning, and an LED 318 indicating a state of the lock part and the like, for example.

Here, functions of the helmet part 201 included in the safety system 200 shown in FIG. 2 are realized by: the input/output interface 305 that accepts the detection result of the heartbeat sensor 306 shown in FIG. 3 that realizes the wearing sensor 202; and the CPU 301 and the RAM 302 that execute appropriate programs to drive the communication interface 304, the input/output interface 305, and the heartbeat sensor 306, the CPU 301 and the RAM 302 transmitting the detection result of the heartbeat sensor 306 to the helmet part 300 via the communication interface 304. The various programs described above, the detection result by the heartbeat sensor 306, and the like can also be stored in the ROM 303.

A function of the permission unit 204 of the lock part 203 included in the safety system 200 shown in FIG. 2 is implemented by: the communication interface 314 shown in FIG. 3 that receives the detection result transmitted from the wearing sensor of the helmet part; and the CPU 311 and the RAM 312 that appropriately execute various programs held in the ROM 313, the CPU 311 and the RAM 312 transmitting a signal for controlling the manual unlocking in accordance with the received detection result to the actuator 316 via the input/output interface 315 or transmitting a signal to the speaker 317 that emits a warning, the LED 318, or the like via the input/output interface 315.

### <Processing Flow>

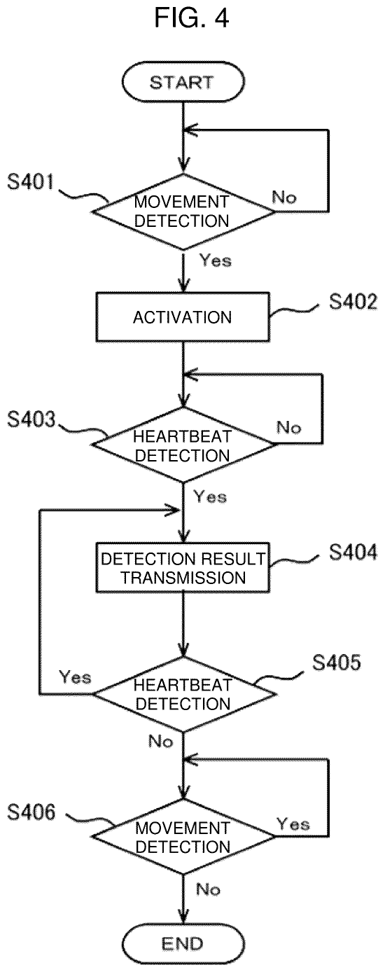

FIG. 4 is a flow diagram showing a flow example of processing of the helmet part. As shown in FIG. 4, helmet movement detection is first performed (S401). Helmet movement detection is performed continuously when a movement is not detected, and the heartbeat sensor of the helmet part or the transmission means is activated when a movement is detected (S402). Then, heartbeat detection is performed (S403). Heartbeat detection is performed continuously while a heartbeat is not detected, and a detection result indicating that a heartbeat is detected is transmitted to the lock part when a heartbeat is detected (S404). Further heartbeat detection is performed (S405), and a detection result thereof is transmitted while the heartbeat is detected. This means transmitting to the lock part whether the helmet continues to be worn. As long as a heartbeat is not detected in S405, helmet movement detection is performed (S406). When helmet movement is no longer detected, the processing flow ends.

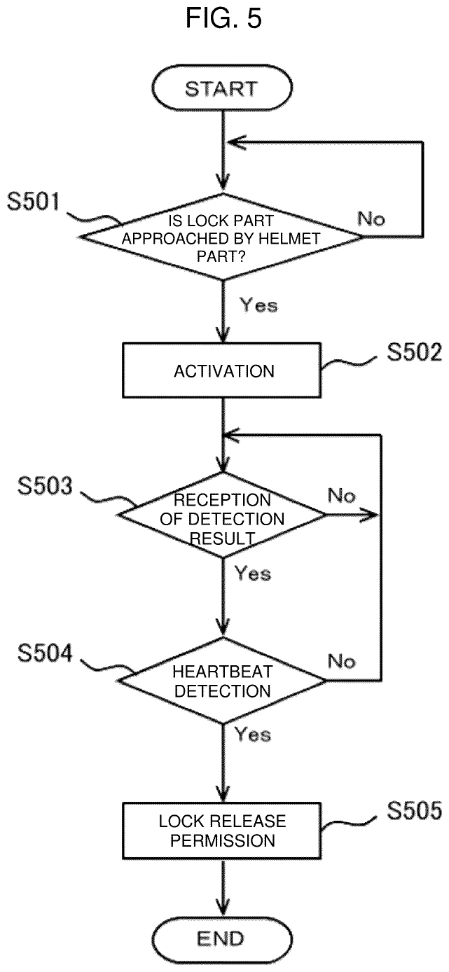

FIG. 5 is a flow diagram showing a flow example of processing of permitting the lock mechanism of the lock part to be released. As shown in FIG. 5, determination is first performed as to whether the lock part is approached by the helmet part (S501). Until it is determined that the lock part is approached by the helmet part, processing for determining whether the lock part is approached by the helmet part is performed continuously. When it is determined that the lock part is approached by the helmet part by receiving any type data, the lock part is activated (S502) from the power-saving mode. Then, determination is performed as to whether the detection result is received from the helmet part (S503). Determination of reception of the detection result is performed continuously when a determination result indicates that the detection result is not received, and further determination is performed as to whether the detection result indicates that a heartbeat is detected when the determination result indicates that the detection result is received (S504). The determination processing of S503 described above is performed as long as the determination is negative, and release of the lock mechanism is permitted when the detection result indicates that a heartbeat is detected (S505).

### <Effect>

According to the present embodiment, helmet wearing is safely and reliably encouraged without causing a dangerous situation in which the wheel immediately locks even when a state is erroneously detected in which a helmet is not being worn, since manual release of the lock mechanism is permitted when helmet wearing is detected by the wearing sensor.

### REFERENCE SIGNS LIST

101: helmet
102: belt
103: helmet part
104: heartbeat sensor
105: lock part
106: knob
107: bolt
108: keyhole
109: light-emitting element
200: safety system
201: helmet part
202: wearing sensor
203: lock part
204: permission unit
205: lock mechanism

1-6. (canceled)

7. A safety system comprising:
a helmet part that is attachable to a helmet; and
a lock part that is attachable to a vehicle and can lock the vehicle, wherein
the helmet part includes a wearing sensor that detects that the helmet is being worn, and
the lock part includes:
a lock mechanism that releases a lock of the vehicle through manual unlocking; and
a permission unit that permits the manual unlocking of the lock mechanism when wearing of the helmet is detected by the wearing sensor.

8. The safety system according to claim 7, wherein the wearing sensor is activated by detecting a movement of the helmet.

9. The safety system according to claim 8, wherein the lock part is activated by approaching of the helmet part with the wearing sensor activated.

10. The safety system according to claim 7, further comprising an alarm unit that emits an alarm when the helmet is removed.

11. The safety system according to claim 7, wherein the wearing sensor is a heartbeat sensor.

12. An operation method for a safety system, the safety system comprising:
a helmet part that is attachable to a helmet; and
a lock part that is attachable to a vehicle and can lock the vehicle, wherein
the helmet part includes a wearing sensor that detects that the helmet is being worn, and
the lock part includes a lock mechanism that releases a lock of the vehicle through manual unlocking, and
the operation method includes a permission step of permitting the manual unlocking of the lock mechanism when wearing of the helmet is detected by the wearing sensor.
